(19) United States
(12) Patent Application Publication
(10) Pub. No.: US 2026/0110847 A1
(43) Pub. Date: Apr. 23, 2026

(54) C AND L BANDED WAVELENGTH SELECTIVE SWITCH WITH HIGH OUTPUT PORT COUNT

(71) Applicant: Lumentum Operations LLC, San Jose, CA (US)

(72) Inventor: Kwun Sing CHAN, Ottawa (CA)

(21) Appl. No.: 18/960,976

(22) Filed: Nov. 26, 2024

Related U.S. Application Data
(60) Provisional application No. 63/708,573, filed on Oct. 17, 2024.

(51) Int. Cl. G02B 6/35

(52) U.S. Cl. CPC G02B 6/3512; G02B 6/3534; G02B 6/3588

(57) ABSTRACT

A wavelength selective switch includes a first input configured to provide a first light beam in a first wavelength band; first outputs dedicated to the first input; a second input spatially offset from the first input, wherein the second input is configured to provide a second light beam in a second wavelength band that does not overlap with the first wavelength band; second outputs dedicated to the second input; a wavelength dispersion element configured to separate the first light beam into first sub-beams, and separate the second light beam into second sub-beams; and a beam steering device configured to: in a wavelength-selective manner, redirect the first sub-beams to couple the first sub-beams into one or more first outputs of the first outputs, and in a wavelength-selective manner, redirect the second sub-beams to couple the second sub-beams into one or more second outputs of the second outputs.

### CROSS-REFERENCE TO RELATED APPLICATION

This Patent Application claims priority to U.S. Provisional Patent Application No. 63/708,573, filed on Oct. 17, 2024, and entitled “HIGH RESOLUTION, WIDE BAND, INTEGRATED INPUT CROSS-CONNECT LINE WAVELENGTH SELECTIVE SWITCH WITH TWO-DIMENSIONAL FIBER ARRAY.” The disclosure of the prior Application is considered part of and is incorporated by reference into this Patent Application.

### TECHNICAL FIELD

The present disclosure relates generally to wavelength selective switches.

### BACKGROUND

A wavelength selective switch (WSS) is widely used for dynamic routing of wavelength channels in optical communications networks. A WSS may be used in dense wavelength division multiplexing (DWDM) systems, where the WSS enables the routing of specific wavelengths (or channels) of light from one fiber to another. WSS devices may be deployed in optical switching nodes of long-haul, regional, and metro optical communications networks.

Long-wavelength band and conventional band ranges are typically referred to as L band and C band, respectively. There is a growing demand for wide band (C+L band) and high port count WSS devices in the industry. These WSS devices need to allow for selecting a flexible optical channel width to be directed to an output. Setting a channel width of a channel, and beam steering of the channel, are usually accomplished by a liquid crystal on silicon (LCOS) chip. An LCOS is a miniaturized reflective active-matrix liquid-crystal display or “microdisplay” using a liquid crystal layer on top of a silicon backplane. The LCOS may also be referred to as a spatial light modulator or director array.

### SUMMARY

In some implementations, a wavelength selective switch includes a switching engine configured to steer light; a wavelength dispersion element bidirectionally optically coupled to the switching engine; a first fiber array unit comprising a first input optical fiber and a plurality of first output optical fibers, wherein the first input optical fiber is capable of supporting a first wavelength band and a second wavelength band, wherein the first input optical fiber is configured to provide a first light beam comprising a first plurality of wavelength channels in a first wavelength band; a second fiber array unit comprising a second input optical fiber and a plurality of second output optical fibers, wherein the second input optical fiber is capable of supporting the first wavelength band and the second wavelength band, wherein the second input optical fiber is configured to provide a second light beam comprising a second plurality of wavelength channels in a second wavelength band, wherein the first wavelength band and the second wavelength band are mutually exclusive wavelength bands, wherein the first input optical fiber and the second input optical fiber are arranged such that, spatially, the first light beam and the second light beam partially overlap with a spatial offset; a first imaging element configured to image the first light beam and the second light beam, at an infinite conjugate plane, onto the wavelength dispersion element, wherein the wavelength dispersion element is configured to disperse the first plurality of wavelength channels into a first group of sub-beams and disperse the second plurality of wavelength channels into a second group of sub-beams; and a second imaging element configured to image the first group of sub-beams and the second group of sub-beams, at a focal plane, onto the switching engine, wherein the switching engine is configured to, in a first wavelength-selective manner, redirect the first group of sub-beams to couple the first group of sub-beams into one or more first output optical fibers of the plurality of first output optical fibers, and wherein the switching engine is configured to, in a second wavelength-selective manner, redirect the second group of sub-beams to couple the second group of sub-beams into one or more second output optical fibers of the plurality of second output optical fibers; and a controller configured, during a first operation mode, to limit the first light beam to the first wavelength band, and limit the second light beam to the second wavelength band.

In some implementations, a wavelength selective switch includes a first input configured to provide a first light beam in a first wavelength band; a plurality of first outputs dedicated to the first input; a second input spatially offset from the first input, wherein the second input is configured to provide a second light beam in a second wavelength band that does not overlap with the first wavelength band; a plurality of second outputs dedicated to the second input; a wavelength dispersion element configured to receive the first light beam, receive the second light beam, separate the first light beam into one or more first sub-beams, and separate the second light beam into one or more second sub-beams; and a beam steering device configured to: in a first wavelength-selective manner, redirect the one or more first sub-beams to couple the one or more first sub-beams into one or more first outputs of the plurality of first outputs, and in a second wavelength-selective manner, redirect the one or more second sub-beams to couple the one or more second sub-beams into one or more second outputs of the plurality of second outputs.

In some implementations, a method includes launching, by a first input, a first light beam into a wavelength selective switch, the first light beam having first wavelength components exclusively within a first wavelength band; launching, by a second input, a second light beam into the wavelength selective switch, the second light beam having second wavelength components exclusively within a second wavelength band that does not overlap with the first wavelength band; imaging, by a first imaging element, the first light beam and the second light beam, at an infinite conjugate plane, onto a wavelength dispersion element; separating, by the wavelength dispersion element, the first wavelength components into a first group of sub-beams; separating, by the wavelength dispersion element, the second wavelength components into a second group of sub-beams; imaging, by a second imaging element, the first group of sub-beams and the second group of sub-beams, at a focal plane, onto a switching engine; independently redirecting, by a switching engine, each sub-beam of the first group of sub-beams to couple the first group of sub-beams into one or more first outputs of a plurality of first outputs, wherein the plurality of first outputs are dedicated to the first input; and independently redirecting, by the switching engine, each sub-beam of the second group of sub-beams to couple the second group of sub-beams into one or more second outputs of a plurality of second outputs, wherein the plurality of second outputs are dedicated to the second input.

### BRIEF DESCRIPTION OF THE DRAWINGS

FIG. 1 shows a WSS according to one or more implementations.

FIG. 2 shows a WSS according to one or more implementations.

FIG. 3 is a flowchart of an example process associated with a C and L banded WSS with high output port count.

### DETAILED DESCRIPTION

The following detailed description of example implementations refers to the accompanying drawings. The same reference numbers in different drawings may identify the same or similar elements.

An input of a WSS may correspond to an incoming optical signal that enters a WSS device. The WSS may provide switching or routing functionality where specific wavelengths are selectively routed between optical fibers, or ports. In this sense, the WSS may provide different optical signal paths or port configurations involved in cross-connecting different optical signals in a WSS device.

Current C and L WSS devices, sometimes referred to as integrated C and L band WSS devices, include inputs that dedicated for C band light or dedicated for L band light. Thus, a first input may be used only for C band light throughout the lifetime of the device, and a second input may be used only for L band light throughout the lifetime of the device. In other words, the first input may provide only C band light, and the second input may provide only L band light. The inputs may share a plurality of outputs, with optics designed to direct the first input and the second input to any of the outputs. However, as a result of the outputs being shared among two different wavelength bands, band splitters are provided at each of the outputs to split light into respective C band light and L band light. The band splitters increase the size, cost, and complexity of the C+L WSS device.

Some implementations described herein provide a C+L banded WSS device. The C+L banded WSS device may include a plurality of inputs, with each input natively designed for both C band light and L band light. Thus, each input is capable of supporting a full C+L band spectrum. The C+L banded WSS device may include a first input/output device (e.g., a first integrated C and L device) and a second input/output device (e.g., a second integrated C and L device device) integrated into a single WSS device, with shared or common optics used for beam shaping, wavelength dispersion, and outputting steering or switching light for both the first input/output device and the second input/output device. The common optics may include a switching engine used to steer respective light of both input/output devices.

The first input/output device may include a plurality of first outputs that are dedicated to a first input. In other words, the plurality of first outputs are optically coupled to the first input and may be arranged to receive light only from light originating from the first input. In addition, the second input/output device may include a plurality of second outputs that are dedicated to a second input. In other words, the plurality of second outputs are optically coupled to the second input and may be arranged to receive light only from light originating from the second input. In some examples, the plurality of first outputs and the plurality of second outputs each include 32 outputs, to form a 64 output WSS device. Some implementations may be directed to high port count WSS devices, where a maximum port count is limited by a steering ranges of the switching engine.

The first input/output device and the second input/output device may each be arranged with a small spatial offset relative to each other such that light from each input/output device spatially overlaps (but not fully overlaps) as the light propagates through the common optics. During operation, the first input/output device and the second input/output device may be limited to different wavelength bands such that there is no wavelength contention between the first input/output device and the second input/output device. For example, the first input/output device may be limited to the C band and the second input/output device may be limited to the L band, or vice versa. In some cases, a controller may configure each input with a particular wavelength band to ensure that there is no wavelength contention between the first input/output device and the second input/output device. Light associated with the first input/output device and light associated with the second input/output device may propagate simultaneously through the common optics and may spatially overlap (but not fully overlap) onto the switching engine. The switching engine may be configured to steer light associated with the first input/output device exclusively to the plurality of first outputs, and steer light associated with the second input/output device exclusively to the plurality of second outputs.

In some implementations, the controller may provide different operation modes during which each input is configured with a different wavelength band. For example, during a first operation mode, the first input may be configured to provide C band light and the second input may be configured to provide L band light. During a second operation mode, the first input may be configured to provide L band light and the second input may be configured to provide C band light. The controller may split the bands between the two inputs at any arbitrary point, since each input is capable of supporting the continuous C and L spectrum. Thus, the controller may limit a type of light that is allowed in each input fiber such that wavelengths for each input fiber do not overlap with wavelengths of a different input fiber.

The C+L banded WSS device may have double an output port count than a single band device, by splitting the inputs and outputs, such that a lateral offset is negligible to the common optics, and to dedicate wavelength bands for each set of inputs/outputs, so that there is no contention between the two systems. Accordingly, a doubling of outputs may be achieved without the use of band splitters.

In some implementations, the C+L banded WSS device is designed as a twin WSS device. Accordingly, the C+L banded WSS device may include a third input/output device (e.g., a third integrated C and L device) and a fourth input/output device (e.g., a fourth integrated C and L device) integrated into the single WSS device, with shared or common second optics used for beam shaping, wavelength dispersion, and outputting steering or switching light for both the third input/output device and the fourth input/output device. The controller may operate the third input/output device and the fourth input/output device such that there is no wavelength contention between the third input/output device and the fourth input/output device, in a similar manner as described for the first input/output device and the second input/output device. An optical design may image pairs of input to a same section on the switching engine, with an option to operate as a contention integrated C and L quad. Then, by limiting functionality via the controller, the device can be operated as a C+L twin WSS.

In some implementations, a C+L banded twin WSS device is provided by using a four-row fiber array input (e.g., 4×40 array). In some examples, the C+L banded twin WSS device may be a C+L banded 2×78 twin WSS device. Instead of imaging four rows to four separate sections on an LCOS, each C/L input pair of the C+L banded 2×78 twin WSS device is imaged to a same section on a switching engine. Typically, there is wavelength contention between the C/L input pair pairs imaged to a same section, but this is no longer a factor if ports are used as dedicated C or L ports. By using dedicated C or L ports in the C+L banded 2×78 twin WSS device, a size and cost of the WSS can be reduced compared to a true (conventional) 2×78 WSS. Moreover, a steering angle (or range) is required only to accommodate 39 ports instead of 78 ports. The C+L banded twin WSS device is equivalent to a traditional C-band WSS+L-band WSS. The C+L banded twin WSS device may be used as a high port count (HPC) integrated C and L WSS. In addition, the C+L banded twin WSS device may enable a high port count with limited or reduced module height compared to a traditional C-band WSS+L-band WSS. The C+L banded twin WSS device may enable a lower (e.g., smaller) steering angle for port selection. Moreover, the C+L banded twin WSS device may reduce an end-of-life (EOL) sensitivity requirement for an HPC WSS.

A WSS described herein may include optical system contentioned quad integrated C and L modules with limited ports. The ports of the WSS may be banded as C- or L-band to remove contention, and operated as a twin. The WSS may re-define what is meant by integrated C and L. Since amplifiers and transceivers are currently banded, there is no use case for a true integrated C and L WSS device. As a result of designing the WSS as a banded C+L device, the WSS can accommodate both C and L bands in a single WSS device that is equivalent to separate C-band WSS and L-band WSS devices.

In some implementations, a C+L banded twin WSS device includes a 4-row fiber array, the 4 rows being C ports (module 1), L ports (module 1), C ports (module 2), and L ports (module 2). C ports (module 1) and L ports (module 1) are both coupled to an upper half of a switching engine. However, due to a lateral offset in the 4-row fiber array, there is a lateral shift in the respective images on the switching engine (frequency offset). C ports (module 2) and L ports (module 2) are both coupled to a lower half of the switching engine. The frequency offset prevents inadvertent coupling of signals originating from the C ports into the L ports.

In some implementations, a C+L banded twin WSS device includes a 2-row fiber array, a first row of the 2-row fiber array having C ports (module 1) and L ports (module 1), and a second row of the 2-row fiber array having C ports (module 2) and L ports (module 2). C ports (module 1) and L ports (module 1) are both coupled to an upper half of a switching engine, and because there is no lateral offset in the 2-row fiber array, there is no frequency offset. In principle, the C ports and the L ports of module 1 could operate as a ganged twin WSS, with each set of ports transmitting wavelengths from both the C and L bands, with the switching engine controlling the wavelength and port configurations of both WSSs simultaneously (e.g., the same configurations would be done to both WSSs). However, there is so far no known use case for such a ganged twin WSS, and there would be potential for crosstalk between C ports and L ports. C ports (module 2) and L ports (module 2) are both coupled to a lower half of the switching engine.

In some implementations, a C+L banded twin WSS device includes a 2-row fiber array, a first row of the 2-row fiber array having C ports (module 1) and L ports (module 2), and a second row of the 2-row fiber array having L ports (module 1) and C ports (module 2). Module 1 ports are coupled to an upper half of a switching engine, and module 2 ports are coupled to a lower half of the switching engine. Module 1 would have a positive frequency offset between C and L ports (positive frequency gap between C and L channels on the switching engine), and module 2 would have a negative frequency offset between C and L ports (negative frequency gap, or overlapping C and L channels on the switching engine). This can work if the negative frequency offset is smaller than a communication network's channel gap between the C and L bands.

In some implementations, a C+L banded twin WSS device includes a 2-row fiber array, a first row of the 2-row fiber array having C ports (module 1) and C ports (module 2), and a second row of the 2-row fiber array having L ports (module 1) and L ports (module 2). Module 1 ports are coupled to an upper half of a switching engine, and module 2 ports are coupled to a lower half of the switching engine.

In some implementations, a C+L banded twin WSS device includes a 1-row fiber array (e.g., a single-row fiber array), with C and L ports of module 1 and C and L ports of module 2 all in a single row. Module 1 ports are coupled to an upper half of a switching engine, and module 2 ports are coupled to a lower half of the switching engine. This configuration has an advantage of using a single-row fiber array, which is easier to make than a multi-row (two-dimensional (2D)) fiber array, but has disadvantages of having a long fiber array, and potential crosstalk between C ports and L ports.

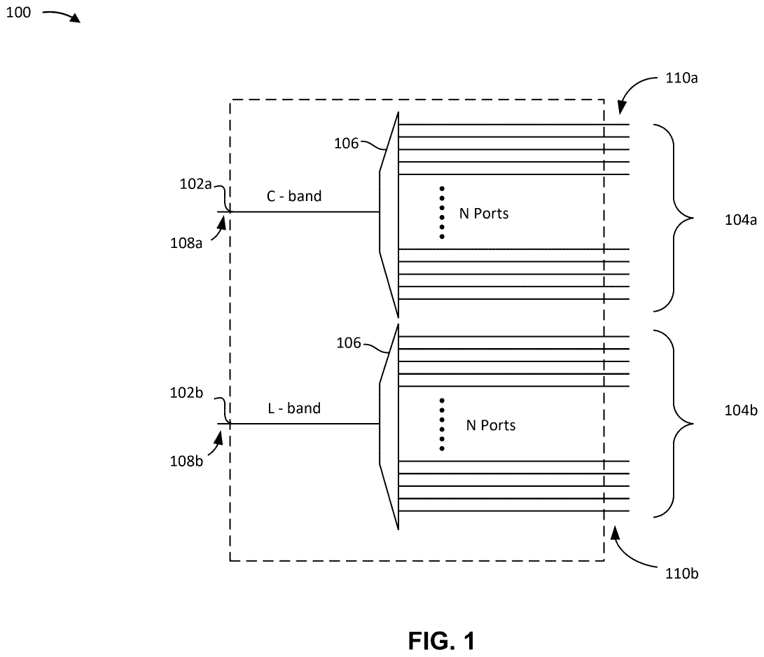

FIG. 1 shows a WSS 100 according to one or more implementations. The WSS 100 may include a first input 102a, a second input 102b, a plurality of first outputs 104a dedicated to the first input 102a, a plurality of second outputs 104b dedicated to the second input 102b, and common optics 106. The common optics 106 may be configured such that the plurality of first outputs 104a are configured to receive light originating from the first input 102a, but are not capable of receiving light from the second input 102b. Additionally, the common optics 106 may be configured such that the plurality of second outputs 104b are configured to receive light originating from the second input 102b, but are not capable of receiving light from the first input 102a. For example, the first input 102a and the second input 102b may be spatially offset from each other such that, spatially, light from the first input 102 and light from the second input 102b partially (but not fully) overlap with a spatial offset. Based on the spatial offset, the common optics 106 is designed to direct light from the first input 102a at one or more first outputs of the plurality of first outputs 104a and avoid directing the light to any of the plurality of second outputs 104b. Additionally, based on the spatial offset, the common optics 106 is designed to direct light from the second input 102b at one or more second outputs of the plurality of second outputs 104b and avoid directing the light to any of the plurality of first outputs 104a.

The first input 102a and the plurality of first outputs 104a may be part of a first input/output device. The second input 102b and the plurality of second outputs 104b may be part of a second input/output device. In some implementations, the first input/output device may be part of or may include a first fiber array unit comprising a first input optical fiber 108a and a plurality of first output optical fibers 110a. The first input optical fiber 108a may be coupled to the first input 102a, and the plurality of first output optical fibers 110a may be respectively coupled to the plurality of first outputs 104a. The second input/output device may be part of or may include a second fiber array unit comprising a second input optical fiber 108b and a plurality of second output optical fibers 110b. The second input optical fiber 108b may be coupled to the second input 102b, and the plurality of second output optical fibers 110b may be respectively coupled to the plurality of second outputs 104b.

The first input/output device and the second input/output device may share the common optics 106, which may be used for beam shaping, wavelength dispersion, and outputting steering or switching light for both the first input/output device and the second input/output device. The common optics 106 may include a switching engine used to steer respective light of both input/output devices. Thus, the first input 102a and the second input 102b may be configured to launch respective light into the common optics 106. In addition, the plurality of first outputs 104a and the plurality of second outputs 104b may receive respective light from the common optics 106.

The first input 102a and the first input optical fiber 108a may be capable of supporting a first wavelength band, such as a C band, and a second wavelength band, such as an L band. In other words, the first input 102a and the first input optical fiber 108a may be natively designed for both C band light and L band light. Thus, the first input 102a and the first input optical fiber 108a may be capable of supporting a full C+L band spectrum. The second input 102b and the second input optical fiber 108b may be capable of supporting the first wavelength band and the second wavelength band. In other words, the second input 102b and the second input optical fiber 108b may be natively designed for both C band light and L band light. Thus, the second input 102b and the second input optical fiber 108b may be capable of supporting a full C+L band spectrum.

In some cases, a controller (not illustrated) may configure the first input 102a and the second input 102b with different wavelength bands to ensure that there is no wavelength contention between the first input/output device and the second input/output device. Light associated with the first input/output device and light associated with the second input/output device may propagate simultaneously through the common optics 106 and may spatially overlap (but not fully overlap) onto the switching engine of the common optics 106. The switching engine may be configured to steer light associated with the first input/output device (e.g., light associated with the first input 102a) exclusively to the plurality of first outputs 104a, and steer light associated with the second input/output device (e.g., light associated with the second input 102b) exclusively to the plurality of second outputs 104b.

In some implementations, the controller may provide different operation modes during which each input is configured with a different wavelength band. For example, during a first operation mode, the first input 102a may be configured to provide C band light and the second input 102b may be configured to provide L band light. During a second operation mode, the first input 102a may be configured to provide L band light and the second input 102b may be configured to provide C band light. Thus, the controller may limit a type of light that is allowed in each of input optical fiber 108a, 108b such that wavelengths for a particular input fiber do not overlap with wavelengths of a different input fiber.

In some implementations, the first input optical fiber 108a may be configured to provide a first light beam that includes a first plurality of wavelength channels in a first wavelength band. Additionally, the second input optical fiber 108b may be configured to provide a second light beam comprising a second plurality of wavelength channels in a second wavelength band. In some implementations, the first light beam and the second light beam may be simultaneously launched into the WSS 100 (e.g., into the common optics 106) such that both the first light beam and the second light beam propagate through the common optics 106. The first wavelength band and the second wavelength band may be mutually exclusive wavelength bands to avoid wavelength contention within the common optics 106. In other words, the first wavelength band and the second wavelength band do not overlap. Thus, the first input 102a may provide the first light beam in the first wavelength band, and the second input 102b may provide the second light beam in the second wavelength band.

The first input optical fiber 108a and the second input optical fiber 108b may be arranged such that, spatially, the first light beam and the second light beam partially overlap with a spatial offset. For example, the first light beam and the second light beam partially overlap within the common optics 106, with no wavelength contention. The controller may, during a first operation mode, limit the first light beam to the first wavelength band, and limit the second light beam to the second wavelength band such that there is no wavelength contention between the first light beam and the second light beam. Put another way, the first light beam may have first wavelength components exclusively within the first wavelength band, and the second light beam may have second wavelength components exclusively within the second wavelength band that do not overlap with the first wavelength band. Thus, the first light beam does not contain wavelength components outside of the first wavelength band, and the second light beam does not contain wavelength components outside of the second wavelength band.

In some implementations, the first input optical fiber 108a and/or the first input 102a are configured to provide a third light beam comprising a third plurality of wavelength channels in the second wavelength band, and the second input optical fiber 108b and/or the second input 102b are configured to provide a fourth light beam comprising a fourth plurality of wavelength channels in the first wavelength band. The controller may, during a second operation mode, limit the third light beam to the second wavelength band, and limit the fourth light beam to the first wavelength band such that there is no wavelength contention between the third light beam and the fourth light beam.

The WSS 100 may be devoid of band splitters. In other words, a configuration of limiting the first light beam and the second light beam to different wavelength bands during operation and having dedicated outputs for each input enables the WSS 100 to be designed without band splitters, which may reduce manufacturing costs of the WSS 100, reduce a size of the WSS 100, and reduce complexity of the WSS 100 in comparison to conventional WSS devices. In addition, the configuration doubles a number of output ports within a single WSS device. Moreover, since the inputs 102a and 102b are natively designed for the full C+L spectrum, the controller may adjust the wavelength band for each input/output device to be anywhere within the full C+L spectrum, so long as the wavelength bands propagating through the common optics 106 do not overlap.

The WSS 100 may be designed as a twin WSS (e.g., a banded iXCL twin WSS or a banded C+L twin WSS device) having one of the twin configurations described herein. For example, the configuration shown in FIG. 1 may be duplicated. The configuration shown in FIG. 1 may be used as a first module (module 1) and the duplicated configuration may be used as a second module (module 2) within a WSS device, thereby forming a twin WSS device. The second module may include a third input/output device (e.g., a third iCL device) and a fourth input/output device (e.g., a fourth iCL device), with shared or common second optics used for beam shaping, wavelength dispersion, and output steering or switching light for both the third input/output device and the fourth input/output device. The common optics of the first module may be separate from the common optics of the second module. In some implementations, the first module and the second module may share the same common optics, including the same switching engine, so long as light of the first module remains spatially separated from the light of the second module. In some implementations, light from the first input/output device and the third input/output device may be limited by the controller to the first wavelength band or to the second wavelength band, and light from the second input/output device and the fourth input/output device may be limited by the controller to the wavelength band not being used by the first input/output device and the third input/output device. In some implementations, light from the first input/output device, the second input/output device, the third input/output device, and the fourth input/output device may be limited by the controller to different, non-overlapping wavelength bands.

As indicated above, FIG. 1 is provided as an example. Other examples may differ from what is described with regard to FIG. 1.

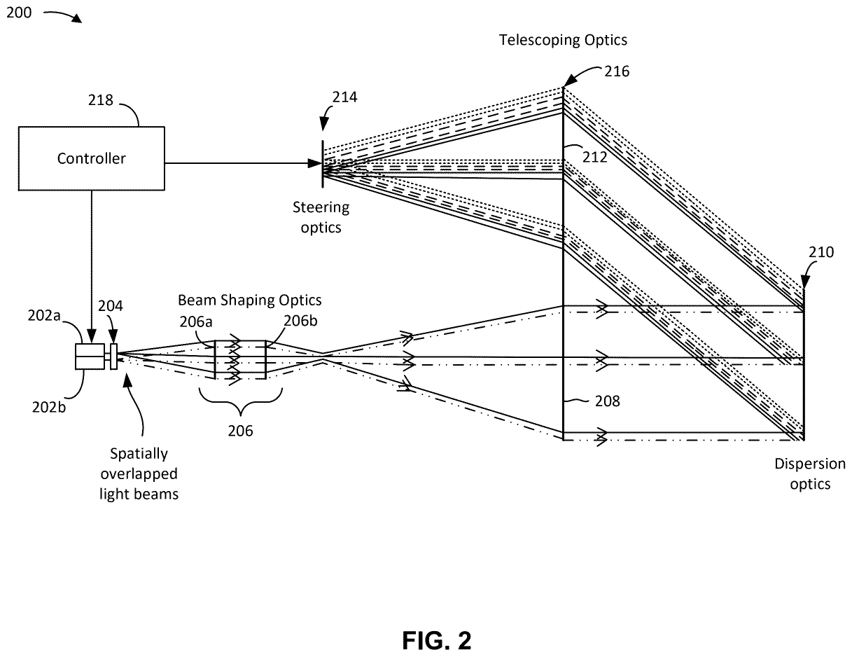

FIG. 2 shows a WSS 200 according to one or more implementations. The WSS 200 may include a first input/output device 200a, such as a first fiber array unit, and a second input/output device 200b, such as a second fiber array unit, similar to those described in connection with FIG. 1. The WSS 200 may include common optics that may include a micro collimator lens array 204, beam shaping optics 206, a first imaging element 208, a wavelength dispersion element 210, a second imaging element 212, and/or a switching engine 214. The common optics may correspond to the common optics 106 described in connection with FIG. 1.

The beam shaping optics 206 may receive the first light beam and the second light beam, as spatially overlapped beams, from the micro collimator lens array 204. The beam shaping optics 206 may shape or otherwise condition the first light beam and the second light beam so that the first light beam and the second light beam impinge upon the wavelength dispersion element 210 and/or the switching engine 214 with a desired shape, angle, and/or magnification. For example, the beam shaping optics 206 may shape the first light beam and the second light beam into narrow lines of light. The beam shaping optics 206 may be optically coupled to the first imaging element 208. Accordingly, the beam shaping optics 206 may receive the first light beam and the second light beam from the first input/output device 200a and the second input/output device 200b, respectively, shape the first light beam and the second light beam into narrow lines of light, and direct the narrow lines of light toward the first imaging element 208. In some implementations, the beam shaping optics 206 may include a first beam shaping component 206a and a second beam shaping component 206b used in combination to shape and condition light.

The first imaging element 208 may image the first light beam and the second light beam, at an infinite conjugate plane, onto the wavelength dispersion element 210.

The wavelength dispersion element 210 may disperse the first plurality of wavelength channels of the first light beam, by wavelength, into a first group of sub-beams, and may disperse the second plurality of wavelength channels of the second light beam, by wavelength, into a second group of sub-beams. In other words, the wavelength dispersion element 210 may separate the first light beam, by wavelength, into one or more first sub-beams, and separate the second light beam, by wavelength, into one or more second sub-beams. The wavelength dispersion element 210 may include a component positioned to separate a beam of light into a group of sub-beams (e.g., having different wavelengths) for transmission toward the switching engine 214 in a forward propagation direction, and/or recombine sub-beams of light for transmission toward the first input/output device 200a and the second input/output device 200b in a counter propagation direction that is counter to the forward propagation direction. For example, the wavelength dispersion element 210 may include a prism, a diffraction grating, or the like. By way of example, the wavelength dispersion element 210 is a reflective diffraction grating in FIG. 2. In some implementations, a reflective grism (e.g., a compound optical element composed of a grating and one or prisms) may be used as a reflective diffraction grating. The reflective diffraction grating may enable a more compact design and reduce losses compared to other types of wavelength dispersion elements.

The second imaging element 212 may image the first group of sub-beams and the second group of sub-beams, at a focal plane, onto the switching engine 214. In some implementations, the first imaging element 208 may be a collimating element configured to image the first light beam and the second light beam onto the wavelength dispersion element 210. The second imaging element 212 may be a focusing element configured to image the first group of sub-beams (e.g., the one or more first sub-beams) and the second group of sub-beams (e.g., the one or more second sub-beams) onto the switching engine 214. The first imaging element 208 and the second imaging element 212 may perform different optical functions depending on a propagation direction of light. For example, the first imaging element 208 may be a first collimating element in the forward propagation direction and a first focusing element in the counter propagation direction. The second imaging element 212 may be a second focusing element in the forward propagation direction and a second collimating element in the counter propagation direction. In some implementations, the first imaging element 208 and the second imaging element 212 may be part of telescoping optics 216.

The switching engine 214 may, in a first wavelength-selective manner, redirect the first group of sub-beams to couple the first group of sub-beams into one or more first output optical fibers of the plurality of first output optical fibers. Put another way, the switching engine 214 may redirect each sub-beam according to a wavelength of that sub-beam. In addition, the switching engine 214 may, in a second wavelength-selective manner, redirect the second group of sub-beams to couple the second group of sub-beams into one or more second output optical fibers of the plurality of second output optical fibers. Thus, the switching engine 214 may individually redirect each sub-beam of the first group of sub-beams to couple each sub-beam of the first group of sub-beams into a respective first output optical fiber of the plurality of first output optical fibers of the first input/output device 202a. In addition, the switching engine 214 may individually redirect each sub-beam of the second group of sub-beams to couple each sub-beam of the second group of sub-beams into a respective second output optical fiber of the plurality of second output optical fibers of the second input/output device 202b.

The switching engine 214 may redirect the first group of sub-beams and the second group of sub-beams to propagate back to the first input/output device 202a and the second input/output device 202b, respectively, via the second imaging element 212, the wavelength dispersion element 210, and the first imaging element 208. In other words, the switching engine 214 may redirect the first group of sub-beams and the second group of sub-beams to propagate back through the common optics in the counter propagation direction. The first group of sub-beams may be spatially offset from the second group of sub-beams at the switching engine 214. The spatial offset at the switching engine 214 may enable the switching engine 214 to exclusively steer the first group of sub-beams back toward the first input/output device 202a, and to exclusively steer the second group of sub-beams back toward the second input/output device 202b.

The switching engine 214 (sometimes referred to as a switching element, a modifying element, or a beam steering device) may include a component capable of modifying and/or redirecting a light beam (e.g., a sub-beam provided by the wavelength dispersion element 210) such that the light beam may be switched between output optical fibers associated with WSS 200. For example, the switching engine 214 may include a micro-electro-mechanical system (MEMS) array that includes a set of movable micromirrors, an LCOS phase modulator array, a liquid crystal polarization rotating element and birefringent beam steering element, or the like. The switching engine 214 may steer sub-beams originating from the first input/output device 202a exclusively among the outputs of the first input/output device 202a, and may steer sub-beams originating from the second input/output device 202b exclusively among the outputs of the second input/output device 202b. Thus, the switching engine 214 may independently redirect each sub-beam of the first group of sub-beams to couple the first group of sub-beams into one or more first outputs of the plurality of first outputs, the plurality of first outputs being dedicated to the first input, and may independently redirect each sub-beam of the second group of sub-beams to couple the second group of sub-beams into one or more second outputs of the plurality of second outputs, the plurality of second outputs being dedicated to the second input.

A controller 218 may control an output steering of the switching engine 214. For example, the controller 218 may control how the switching engine 214 modulates or steers each sub-beam (e.g., each wavelength channel or wavelength component). The controller 218 may control which outputs receive light and which wavelength an output receives. The controller 218 may control an angle of reflection or steering angle at which the switching engine 214 redirects a sub-beam. Thus, the controller 218 may select which output among the plurality of first outputs a sub-beam of the first group of sub-beams is directed to by the switching engine 214. Similarly, the controller 218 may select which output among the plurality of second outputs a sub-beam of the second group of sub-beams is directed to by the switching engine 214.

In some implementations, the controller 218 may configure the first input of the first input/output device 202a and the second input of the second input/output device 202b with different wavelength bands to ensure that there is no wavelength contention between the first input/output device 202a and the second input/output device 202b (e.g., no wavelength contention between the first light beam and the second light beam). For example, the controller 218 may provide different operation modes during which each input is configured with a different wavelength band. For example, during a first operation mode, the first input may be configured to provide C band light and the second input may be configured to provide L band light. During a second operation mode, the first input may be configured to provide L band light and the second input may be configured to provide C band light. Thus, the controller may limit a type of light that is allowed in each input fiber such that wavelengths for a particular input fiber do not overlap with wavelengths of a different input fiber.

During the first operation mode, the first light beam may include the first plurality of wavelength channels in the first wavelength band, and the second light beam may include the second plurality of wavelength channels in the second wavelength band. The controller 218 may limit the first light beam to the first wavelength band and limit the second light beam to the second wavelength band such that there is no wavelength contention between the first light beam and the second light beam. During the second operation mode, the first input/output device 202a may provide a third light beam, and the second input/output device 202b may provide a fourth light beam. The third light beam may include a third plurality of wavelength channels in the second wavelength band, and the fourth light beam may include a fourth plurality of wavelength channels in the first wavelength band. The controller 218 may limit the third light beam to the second wavelength band and limit the fourth light beam to the first wavelength band such that there is no wavelength contention between the third light beam and the fourth light beam.

The WSS 200 may be designed as a twin WSS (e.g., a C+L banded twin WSS device) having one of the twin configurations described herein.

As indicated above, FIG. 2 is provided as an example. Other examples may differ from what is described with regard to FIG. 2. The number and arrangement of devices and components shown in FIG. 2 are provided as an example. In practice, there may be additional devices or components, fewer devices or components, different devices or components, or differently arranged devices or components than those shown in FIG. 2.

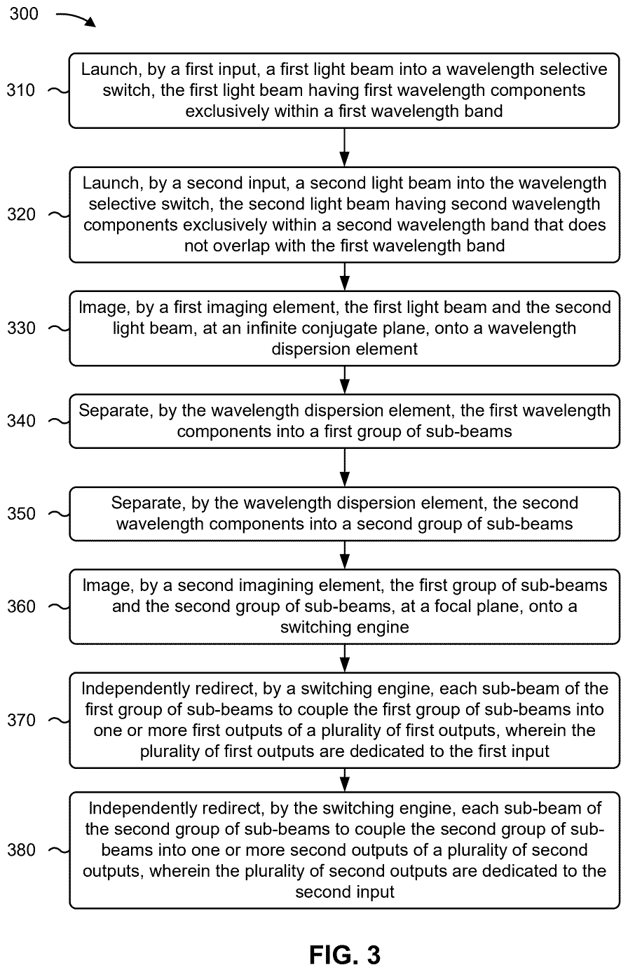

FIG. 3 is a flowchart of an example process 300 associated with a C and L banded WSS with high output port count. In some implementations, one or more process blocks of FIG. 3 are performed by a C and L banded WSS (e.g., WSS 100 and/or WSS 200). In some implementations, one or more process blocks of FIG. 3 are performed by another device or a group of devices separate from or including the C and L banded WSS. Additionally, or alternatively, one or more process blocks of FIG. 3 may be performed by one or more components of the C and L banded WSS.

As shown in FIG. 3, process 300 may include launching a first light beam into a WSS, the first light beam having first wavelength components exclusively within a first wavelength band (block 310). For example, a first input of a WSS may launch the first light beam into the WSS, as described above.

As further shown in FIG. 3, process 300 may include launching a second light beam into the WSS, the second light beam having second wavelength components exclusively within a second wavelength band that does not overlap with the first wavelength band (block 320). For example, a second input of the WSS may launch the second light beam into the WSS, as described above.

As further shown in FIG. 3, process 300 may include imaging the first light beam and the second light beam, at an infinite conjugate plane, onto a wavelength dispersion element (block 330). For example, a first imaging element of the WSS may image the first light beam and the second light beam, at the infinite conjugate plane, onto the wavelength dispersion element, as described above.

As further shown in FIG. 3, process 300 may include separating the first wavelength components into a first group of sub-beams (block 340). For example, a wavelength dispersion element of the WSS may separate the first wavelength components into the first group of sub-beams, as described above.

As further shown in FIG. 3, process 300 may include separating the second wavelength components into a second group of sub-beams (block 350). For example, the wavelength dispersion element of the WSS may separate the second wavelength components into the second group of sub-beams, as described above.

As further shown in FIG. 3, process 300 may include imaging the first group of sub-beams and the second group of sub-beams, at a focal plane, onto a switching engine (block 360). For example, a second imaging element of the WSS may image the first group of sub-beams and the second group of sub-beams, at the focal plane, onto the switching engine, as described above.

As further shown in FIG. 3, process 300 may include independently redirecting each sub-beam of the first group of sub-beams to couple the first group of sub-beams into one or more first outputs of a plurality of first outputs, wherein the plurality of first outputs are dedicated to the first input (block 370). For example, a switching engine of the WSS may independently redirect each sub-beam of the first group of sub-beams to couple the first group of sub-beams into one or more first outputs of a plurality of first outputs, as described above.

As further shown in FIG. 3, process 300 may include independently redirecting each sub-beam of the second group of sub-beams to couple the second group of sub-beams into one or more second outputs of a plurality of second outputs, wherein the plurality of second outputs are dedicated to the second input (block 380). For example, the switching engine of the WSS may independently redirect each sub-beam of the second group of sub-beams to couple the second group of sub-beams into one or more second outputs of the plurality of second outputs, as described above.

Process 300 may include additional implementations, such as any single implementation or any combination of implementations described below and/or in connection with one or more other processes described elsewhere herein.

In a first implementation, the first light beam and the second light beam are simultaneously launched into the WSS.

In a second implementation, the first light beam is conventional-wavelength band (C-band) light, and the second light beam is long-wavelength band (L-band) light.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The following provides an overview of some Aspects of the present disclosure:
Aspect 1: A wavelength selective switch, comprising: a switching engine configured to steer light; a wavelength dispersion element bidirectionally optically coupled to the switching engine; a first fiber array unit comprising a first input optical fiber and a plurality of first output optical fibers, wherein the first input optical fiber is capable of supporting a first wavelength band and a second wavelength band, wherein the first input optical fiber is configured to provide a first light beam comprising a first plurality of wavelength channels in a first wavelength band; a second fiber array unit comprising a second input optical fiber and a plurality of second output optical fibers, wherein the second input optical fiber is capable of supporting the first wavelength band and the second wavelength band, wherein the second input optical fiber is configured to provide a second light beam comprising a second plurality of wavelength channels in a second wavelength band, wherein the first wavelength band and the second wavelength band are mutually exclusive wavelength bands, wherein the first input optical fiber and the second input optical fiber are arranged such that, spatially, the first light beam and the second light beam partially overlap with a spatial offset; a first imaging element configured to image the first light beam and the second light beam, at an infinite conjugate plane, onto the wavelength dispersion element, wherein the wavelength dispersion element is configured to disperse the first plurality of wavelength channels into a first group of sub-beams and disperse the second plurality of wavelength channels into a second group of sub-beams; and a second imaging element configured to image the first group of sub-beams and the second group of sub-beams, at a focal plane, onto the switching engine, wherein the switching engine is configured to, in a first wavelength-selective manner, redirect the first group of sub-beams to couple the first group of sub-beams into one or more first output optical fibers of the plurality of first output optical fibers, and wherein the switching engine is configured to, in a second wavelength-selective manner, redirect the second group of sub-beams to couple the second group of sub-beams into one or more second output optical fibers of the plurality of second output optical fibers; and a controller configured, during a first operation mode, to limit the first light beam to the first wavelength band, and limit the second light beam to the second wavelength band.
Aspect 2: The wavelength selective switch of Aspect 1, wherein the first input optical fiber is configured to provide a third light beam comprising a third plurality of wavelength channels in the second wavelength band, wherein the second input optical fiber is configured to provide a fourth light beam comprising a fourth plurality of wavelength channels in the first wavelength band, and wherein the controller, during a second operation mode, is configured to limit the third light beam to the second wavelength band, and limit the fourth light beam to the first wavelength band.
Aspect 3: The wavelength selective switch of any of Aspects 1-2, wherein the switching engine is configured to individually redirect each sub-beam of the first group of sub-beams to couple each sub-beam of the first group of sub-beams into a respective first output optical fiber of the plurality of first output optical fibers, and wherein the switching engine is configured to individually redirect each sub-beam of the second group of sub-beams to couple each sub-beam of the second group of sub-beams into a respective second output optical fiber of the plurality of second output optical fibers.
Aspect 4: The wavelength selective switch of any of Aspects 1-3, wherein the switching engine is configured to redirect the first group of sub-beams and the second group of sub-beams to propagate back to the first fiber array unit and the second fiber array unit, respectively, via the second imaging element, the wavelength dispersion element, and the first imaging element.
Aspect 5: The wavelength selective switch of any of Aspects 1-4, wherein the wavelength dispersion element is a reflective diffraction grating.
Aspect 6: The wavelength selective switch of any of Aspects 1-5, further comprising: an optical component comprising the first imaging element and the second imaging element.
Aspect 7: The wavelength selective switch of any of Aspects 1-6, wherein the first imaging element is a first collimating element in a forward propagation direction and a first focusing element in a counter propagation direction, and wherein the second imaging element is a second focusing element in the forward propagation direction and a second collimating element in the counter propagation direction.
Aspect 8: The wavelength selective switch of any of Aspects 1-7, further comprising: beam shaping optics optically coupled to the first imaging element, wherein the beam shaping optics are configured to receive the first light beam and the second light beam from the first fiber array unit and the second fiber array unit, respectively, shape the first light beam and the second light beam into narrow lines of light, and direct the narrow lines of light toward the first imaging element.
Aspect 9: The wavelength selective switch of any of Aspects 1-8, wherein the first wavelength band is a first one of a conventional-wavelength band (C-band) or a long-wavelength band (L-band), and wherein the second wavelength band is a second one of the C-band or the L-band.
Aspect 10: The wavelength selective switch of any of Aspects 1-9, wherein the switching engine is a liquid-crystal-on-silicon (LCOS) array or a microelectromechanical system (MEMS) array of micromirrors.
Aspect 11: The wavelength selective switch of any of Aspects 1-10, wherein the first group of sub-beams are spatially offset from the second group of sub-beams at the switching engine.
Aspect 12: A wavelength selective switch, comprising: a first input configured to provide a first light beam in a first wavelength band; a plurality of first outputs dedicated to the first input; a second input spatially offset from the first input, wherein the second input is configured to provide a second light beam in a second wavelength band that does not overlap with the first wavelength band; a plurality of second outputs dedicated to the second input; a wavelength dispersion element configured to receive the first light beam, receive the second light beam, separate the first light beam into one or more first sub-beams, and separate the second light beam into one or more second sub-beams; and a beam steering device configured to: in a first wavelength-selective manner, redirect the one or more first sub-beams to couple the one or more first sub-beams into one or more first outputs of the plurality of first outputs, and in a second wavelength-selective manner, redirect the one or more second sub-beams to couple the one or more second sub-beams into one or more second outputs of the plurality of second outputs.
Aspect 13: The wavelength selective switch of Aspect 12, wherein the beam steering device is configured to individually redirect each first sub-beam of the one or more first sub-beams to couple each first sub-beam of the one or more first sub-beams into a respective first output of the plurality of first outputs, and wherein the beam steering device is configured to individually redirect each second sub-beam of the one or more second sub-beams to couple each second sub-beam of the one or more second sub-beams into a respective second output of the plurality of second outputs.
Aspect 14: The wavelength selective switch of any of Aspects 12-13, wherein the first input and the second input are configured to simultaneously provide the first light beam and the second light beam such that the first light beam and the second light beam spatially overlap, with a spatial offset, within the wavelength selective switch.
Aspect 15: The wavelength selective switch of any of Aspects 12-14, further comprising: a collimating element configured to image the first light beam and the second light beam onto the wavelength dispersion element; and a focusing element configured to image the one or more first sub-beams and the one or more second sub-beams onto the beam steering device.
Aspect 16: The wavelength selective switch of Aspect 15, wherein the focusing element is configured to image the one or more first sub-beams and the one or more second sub-beams onto the beam steering device with a spatial offset.
Aspect 17: The wavelength selective switch of Aspect 15, wherein the beam steering device is configured to redirect the one or more first sub-beams and the one or more second sub-beams to propagate back to the plurality of first outputs and the plurality of second outputs, respectively, via the focusing element, the wavelength dispersion element, and the collimating element.
Aspect 18: The wavelength selective switch of any of Aspects 12-17, wherein the first wavelength band is a first one of a conventional-wavelength band (C-band) or a long-wavelength band (L-band), and wherein the second wavelength band is a second one of the C-band or the L-band.
Aspect 19: The wavelength selective switch of any of Aspects 12-18, wherein the wavelength dispersion element is a diffraction grating.
Aspect 20: A method, comprising: launching, by a first input, a first light beam into a wavelength selective switch, the first light beam having first wavelength components exclusively within a first wavelength band; launching, by a second input, a second light beam into the wavelength selective switch, the second light beam having second wavelength components exclusively within a second wavelength band that does not overlap with the first wavelength band; imaging, by a first imaging element, the first light beam and the second light beam, at an infinite conjugate plane, onto a wavelength dispersion element; separating, by the wavelength dispersion element, the first wavelength components into a first group of sub-beams; separating, by the wavelength dispersion element, the second wavelength components into a second group of sub-beams; imaging, by a second imaging element, the first group of sub-beams and the second group of sub-beams, at a focal plane, onto a switching engine; independently redirecting, by a switching engine, each sub-beam of the first group of sub-beams to couple the first group of sub-beams into one or more first outputs of a plurality of first outputs, wherein the plurality of first outputs are dedicated to the first input; and independently redirecting, by the switching engine, each sub-beam of the second group of sub-beams to couple the second group of sub-beams into one or more second outputs of a plurality of second outputs, wherein the plurality of second outputs are dedicated to the second input.
Aspect 21: The method of Aspect 20, wherein the first light beam and the second light beam are simultaneously launched into the wavelength selective switch.
Aspect 22: The method of any of Aspects 20-21, wherein the first light beam is conventional-wavelength band (C-band) light, and wherein the second light beam is long-wavelength band (L-band) light.
Aspect 23: A system configured to perform one or more operations recited in one or more of Aspects 1-22.
Aspect 24: An apparatus comprising means for performing one or more operations recited in one or more of Aspects 1-22.
Aspect 25: A non-transitory computer-readable medium storing a set of instructions, the set of instructions comprising one or more instructions that, when executed by a device, cause the device to perform one or more operations recited in one or more of Aspects 1-22.
Aspect 26: A computer program product comprising instructions or code for executing one or more operations recited in one or more of Aspects 1-22.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A wavelength selective switch, comprising:
a switching engine configured to steer light;
a wavelength dispersion element bidirectionally optically coupled to the switching engine;
a first fiber array unit comprising a first input optical fiber and a plurality of first output optical fibers,
wherein the first input optical fiber is capable of supporting a first wavelength band and a second wavelength band,
wherein the first input optical fiber is configured to provide a first light beam comprising a first plurality of wavelength channels in a first wavelength band;
a second fiber array unit comprising a second input optical fiber and a plurality of second output optical fibers,
wherein the second input optical fiber is capable of supporting the first wavelength band and the second wavelength band,
wherein the second input optical fiber is configured to provide a second light beam comprising a second plurality of wavelength channels in a second wavelength band,
wherein the first wavelength band and the second wavelength band are mutually exclusive wavelength bands,
wherein the first input optical fiber and the second input optical fiber are arranged such that, spatially, the first light beam and the second light beam partially overlap with a spatial offset;
a first imaging element configured to image the first light beam and the second light beam, at an infinite conjugate plane, onto the wavelength dispersion element,
wherein the wavelength dispersion element is configured to disperse the first plurality of wavelength channels into a first group of sub-beams and disperse the second plurality of wavelength channels into a second group of sub-beams; and
a second imaging element configured to image the first group of sub-beams and the second group of sub-beams, at a focal plane, onto the switching engine,
wherein the switching engine is configured to, in a first wavelength-selective manner, redirect the first group of sub-beams to couple the first group of sub-beams into one or more first output optical fibers of the plurality of first output optical fibers, and
wherein the switching engine is configured to, in a second wavelength-selective manner, redirect the second group of sub-beams to couple the second group of sub-beams into one or more second output optical fibers of the plurality of second output optical fibers; and
a controller configured, during a first operation mode, to limit the first light beam to the first wavelength band, and limit the second light beam to the second wavelength band.

2. The wavelength selective switch of claim 1, wherein the first input optical fiber is configured to provide a third light beam comprising a third plurality of wavelength channels in the second wavelength band,
wherein the second input optical fiber is configured to provide a fourth light beam comprising a fourth plurality of wavelength channels in the first wavelength band, and
wherein the controller, during a second operation mode, is configured to limit the third light beam to the second wavelength band, and limit the fourth light beam to the first wavelength band.

3. The wavelength selective switch of claim 1, wherein the switching engine is configured to individually redirect each sub-beam of the first group of sub-beams to couple each sub-beam of the first group of sub-beams into a respective first output optical fiber of the plurality of first output optical fibers, and
wherein the switching engine is configured to individually redirect each sub-beam of the second group of sub-beams to couple each sub-beam of the second group of sub-beams into a respective second output optical fiber of the plurality of second output optical fibers.

4. The wavelength selective switch of claim 1, wherein the switching engine is configured to redirect the first group of sub-beams and the second group of sub-beams to propagate back to the first fiber array unit and the second fiber array unit, respectively, via the second imaging element, the wavelength dispersion element, and the first imaging element.

5. The wavelength selective switch of claim 1, wherein the wavelength dispersion element is a reflective diffraction grating.

6. The wavelength selective switch of claim 1, further comprising:
an optical component comprising the first imaging element and the second imaging element.

7. The wavelength selective switch of claim 1, wherein the first imaging element is a first collimating element in a forward propagation direction and a first focusing element in a counter propagation direction, and
wherein the second imaging element is a second focusing element in the forward propagation direction and a second collimating element in the counter propagation direction.

8. The wavelength selective switch of claim 1, further comprising:
beam shaping optics optically coupled to the first imaging element, wherein the beam shaping optics are configured to receive the first light beam and the second light beam from the first fiber array unit and the second fiber array unit, respectively, shape the first light beam and the second light beam into narrow lines of light, and direct the narrow lines of light toward the first imaging element.

9. The wavelength selective switch of claim 1, wherein the first wavelength band is a first one of a conventional-wavelength band (C-band) or a long-wavelength band (L-band), and
wherein the second wavelength band is a second one of the C-band or the L-band.

10. The wavelength selective switch of claim 1, wherein the switching engine is a liquid-crystal-on-silicon (LCOS) array or a microelectromechanical system (MEMS) array of micromirrors.

11. The wavelength selective switch of claim 1, wherein the first group of sub-beams are spatially offset from the second group of sub-beams at the switching engine.

12. A wavelength selective switch, comprising:
a first input configured to provide a first light beam in a first wavelength band;
a plurality of first outputs dedicated to the first input;
a second input spatially offset from the first input, wherein the second input is configured to provide a second light beam in a second wavelength band that does not overlap with the first wavelength band;
a plurality of second outputs dedicated to the second input;
a wavelength dispersion element configured to receive the first light beam, receive the second light beam, separate the first light beam into one or more first sub-beams, and separate the second light beam into one or more second sub-beams; and
a beam steering device configured to:
in a first wavelength-selective manner, redirect the one or more first sub-beams to couple the one or more first sub-beams into one or more first outputs of the plurality of first outputs, and
in a second wavelength-selective manner, redirect the one or more second sub-beams to couple the one or more second sub-beams into one or more second outputs of the plurality of second outputs.

13. The wavelength selective switch of claim 12, wherein the beam steering device is configured to individually redirect each first sub-beam of the one or more first sub-beams to couple each first sub-beam of the one or more first sub-beams into a respective first output of the plurality of first outputs, and
wherein the beam steering device is configured to individually redirect each second sub-beam of the one or more second sub-beams to couple each second sub-beam of the one or more second sub-beams into a respective second output of the plurality of second outputs.

14. The wavelength selective switch of claim 12, wherein the first input and the second input are configured to simultaneously provide the first light beam and the second light beam such that the first light beam and the second light beam spatially overlap, with a spatial offset, within the wavelength selective switch.

15. The wavelength selective switch of claim 12, further comprising:
a collimating element configured to image the first light beam and the second light beam onto the wavelength dispersion element; and
a focusing element configured to image the one or more first sub-beams and the one or more second sub-beams onto the beam steering device.

16. The wavelength selective switch of claim 15, wherein the focusing element is configured to image the one or more first sub-beams and the one or more second sub-beams onto the beam steering device with a spatial offset.

17. The wavelength selective switch of claim 15, wherein the beam steering device is configured to redirect the one or more first sub-beams and the one or more second sub-beams to propagate back to the plurality of first outputs and the plurality of second outputs, respectively, via the focusing element, the wavelength dispersion element, and the collimating element.

18. The wavelength selective switch of claim 12, wherein the first wavelength band is a first one of a conventional-wavelength band (C-band) or a long-wavelength band (L-band), and
wherein the second wavelength band is a second one of the C-band or the L-band.

19. The wavelength selective switch of claim 12, wherein the wavelength dispersion element is a diffraction grating.

20. A method, comprising:
launching, by a first input, a first light beam into a wavelength selective switch, the first light beam having first wavelength components exclusively within a first wavelength band;
launching, by a second input, a second light beam into the wavelength selective switch, the second light beam having second wavelength components exclusively within a second wavelength band that does not overlap with the first wavelength band;
imaging, by a first imaging element, the first light beam and the second light beam, at an infinite conjugate plane, onto a wavelength dispersion element;
separating, by the wavelength dispersion element, the first wavelength components into a first group of sub-beams;
separating, by the wavelength dispersion element, the second wavelength components into a second group of sub-beams;
imaging, by a second imaging element, the first group of sub-beams and the second group of sub-beams, at a focal plane, onto a switching engine;
independently redirecting, by a switching engine, each sub-beam of the first group of sub-beams to couple the first group of sub-beams into one or more first outputs of a plurality of first outputs, wherein the plurality of first outputs are dedicated to the first input; and
independently redirecting, by the switching engine, each sub-beam of the second group of sub-beams to couple the second group of sub-beams into one or more second outputs of a plurality of second outputs, wherein the plurality of second outputs are dedicated to the second input.

21. The method of claim 20, wherein the first light beam and the second light beam are simultaneously launched into the wavelength selective switch.

22. The method of claim 20, wherein the first light beam is conventional-wavelength band (C-band) light, and
wherein the second light beam is long-wavelength band (L-band) light.
